(19) United States
(12) Patent Application Publication
(10) Pub. No.: US 2019/0311201 A1
(43) Pub. Date: Oct. 10, 2019

(54) BATTERY-POWERED CAMERA WITH REDUCED POWER CONSUMPTION BASED ON MACHINE LEARNING AND OBJECT DETECTION

(71) Applicant: Deep Sentinel Corp., Pleasanton, CA (US)

(72) Inventors: David Lee Selinger, Pleasanton, CA (US); Chaoying Chen, Dublin, CA (US); Kandarp Nyati, San Jose, CA (US)

(21) Appl. No.: 15/948,712

(22) Filed: Apr. 9, 2018

(51) Int. Cl. G06K 9/00; G08B 13/196; H04N 5/232; G06T 1/20; H04N 5/235; G06T 7/11; G06T 7/215; G08B 25/00

(52) U.S. Cl. CPC G06K 9/00744; G08B 13/19636; H04N 5/23216; H04N 5/23254; G06T 1/20; H04N 5/2354; G06T 2207/10016; G08B 13/19656; G06T 7/11; G06T 7/215; G08B 25/006; G06T 2207/20084; G06T 2207/20081; G08B 13/19606

(57) ABSTRACT

Apparatus and associated methods relate to transmitting video frames selected by a camera based on detected motion to a network hub configured with an artificial intelligence adapted to predict a region of interest within the selected video frames, configuring the camera with the region of interest predicted by the hub, and managing the energy consumption of the camera based on automatically governing camera operational parameters adapted as a function of the region of interest. In an illustrative example, the camera may be a battery-powered camera. In some embodiments, the camera may be configured in a low power mode with wireless interfaces off. In various implementations, the camera may be configured to detect motion within a region of interest and ignore motion elsewhere. Various examples may advantageously provide improved camera power management based on governing the camera operational parameters as a function of detected motion and the configured region of interest.

### TECHNICAL FIELD

Various embodiments relate generally to camera power management.

### BACKGROUND

Cameras are generally composed from visual imaging devices. Some visual imaging devices capture optical images based on receiving light through a lens. Cameras may convert received light to a form that can be stored or transferred. For example, a digital camera may employ a sensor to convert received light to digital data that may be stored or transferred to a server or database as data file which may be known as image data. Some cameras are used to capture images of potential interest. For example, a security camera may be oriented to capture images of an area to be protected, such as a home entrance in the visual field of the camera.

Some cameras may be configured to detect motion in video frames of a captured scene. For example, a camera may detect motion based on a comparing a series of video frames with historical frames. Some cameras may ignore video frames without detected motion. A camera configured to ignore video frames without detected motion may, for example, remain in a low-power mode with some camera electronic subsystems powered off, until motion is detected. Some cameras may enter a more fully-powered mode and store, forward, or process video frames with detected motion.

Some cameras are configured with wireless communication interfaces. A camera with a wireless communication interface may be deployed without wired communication links to a location remote from a server or database. Some cameras may be able to capture and transfer an image to a server in response to motion detected by the camera in the camera's visual field. Cameras configured to operate in remote locations may be battery powered. Battery-powered cameras configured to operate at remote locations may have limited battery life. Battery replacement may be inconvenient at some remote camera locations. The useful battery lifetime may limit the usefulness of battery-powered cameras in some locations. Some wireless battery-operated cameras are capable of conserving battery lifetime by powering up for a limited on-time to capture or transfer an image when motion is detected.

Images captured by a camera may be studied by a human or a machine to identify the image content. Some images may contain a representation of an object. Machines may be trained to identify objects represented in an image using techniques from the fields of image processing, machine learning, and artificial intelligence (AI). Machines that are trained to identify objects may be known as artificial intelligence. Some artificial intelligence may be trained to identify a specific individual and classify the individual according to the threat posed by the individual. Object identification by artificial intelligence based on captured images may require substantial computation. Rapid response to threats posed by some identified objects may be necessary.

### SUMMARY

Apparatus and associated methods relate to transmitting video frames selected by a camera based on detected motion to a network hub configured with an artificial intelligence adapted to predict a region of interest within the selected video frames, configuring the camera with the region of interest predicted by the hub, and managing the energy consumption of the camera based on automatically governing camera operational parameters adapted as a function of the region of interest. In an illustrative example, the camera may be a battery-powered camera. In some embodiments, the camera may be configured in a low power mode with wireless interfaces off. In various implementations, the camera may be configured to detect motion within a region of interest and ignore motion elsewhere. Various examples may advantageously provide improved camera power management based on governing the camera operational parameters as a function of detected motion and the configured region of interest.

Various embodiments may achieve one or more advantages. For example, some embodiments may improve the battery lifetime of battery-powered cameras. This facilitation may be a result of limiting the on-time of a motion-detecting battery-powered camera, in response to motion detection by the camera in a visual field region of interest determined by artificial intelligence configured in a network hub. For example, camera triggering may be suppressed for a period of time, in response to detection of objects or motion detected outside a visual field region of interest. In some embodiments, security system response time may be reduced. Such reduced security system response time may be a result of artificial intelligence automatically determining a degree of interest in regions of images captured in response to motion detected by the camera. Some embodiments may increase the accuracy of object identification. Such increased identification accuracy may be a result of automatic adjustments to illumination levels by the artificial intelligence in response to automatic analysis of captured image quality metrics. In some designs, privacy may be enhanced while improving object identification accuracy. This facilitation may be a result of configuring the camera to obscure portions of an image that are not part of a detected object. Various implementations may improve image processing efficiency on the camera. Such increased image processing performance may be a result of reducing the computational workload to process images on the camera. For example, fewer pixels and processor instruction cycles are needed by a camera configured to process a region of interest of an image obtained by cropping the original image.

In some designs, the object classification error rate may be reduced. This facilitation may be a result of automatic adjustments to bitrate by the artificial intelligence in response to automatic analysis of quality metrics of captured images. In some embodiments, the latency required to detect a threat in a captured image may be reduced. Such reduced threat detection latency may be a result of initiating a stream of video frames with detected motion from a camera to a hub configured with artificial intelligence adapted to identify objects and classify objects by type. In various designs, the usability of security threat notifications may be increased. This facilitation may be a result of filtering notifications to a homeowner based on the object type determined by artificial intelligence as a function of an image captured by the camera. In some implementations, camera object tracking accuracy may be increased. Such increased camera object tracking accuracy may be a result of the hub controlling camera pan, tilt, zoom, or focus in response to object types determined by the artificial intelligence as a function of an image captured by the camera. For example, in response to classification by the artificial intelligence of a human as a burglar, the hub may direct the camera to focus on and follow the burglar's movement around the home. Such comprehensive object tracking may enable the hub to provide the burglar's location within a home to law enforcement, enabling a more robust police response.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a collaboration view of an exemplary camera transmitting video frames selected by the camera based on detected motion to a network hub configured with an artificial intelligence adapted to predict a region of interest within the selected video frames, configuring the camera with the region of interest predicted by the hub, and managing the energy consumption of the camera based on automatically governing camera operational parameters adapted as a function of the region of interest.

FIG. 2 depicts a process flow of an exemplary Video Region Management Engine (VRME).

FIG. 3 depicts a process flow of an exemplary Video Camera Management Engine (VCME).

Like reference symbols in the various drawings indicate like elements.

### DETAILED DESCRIPTION OF ILLUSTRATIVE EMBODIMENTS

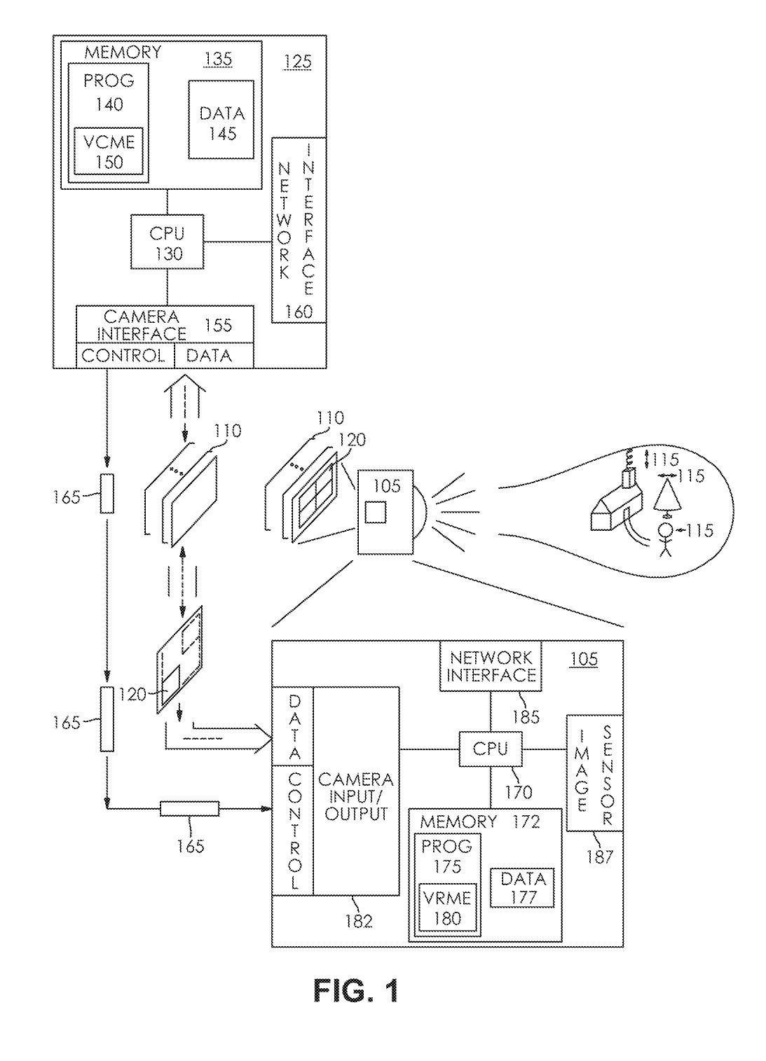

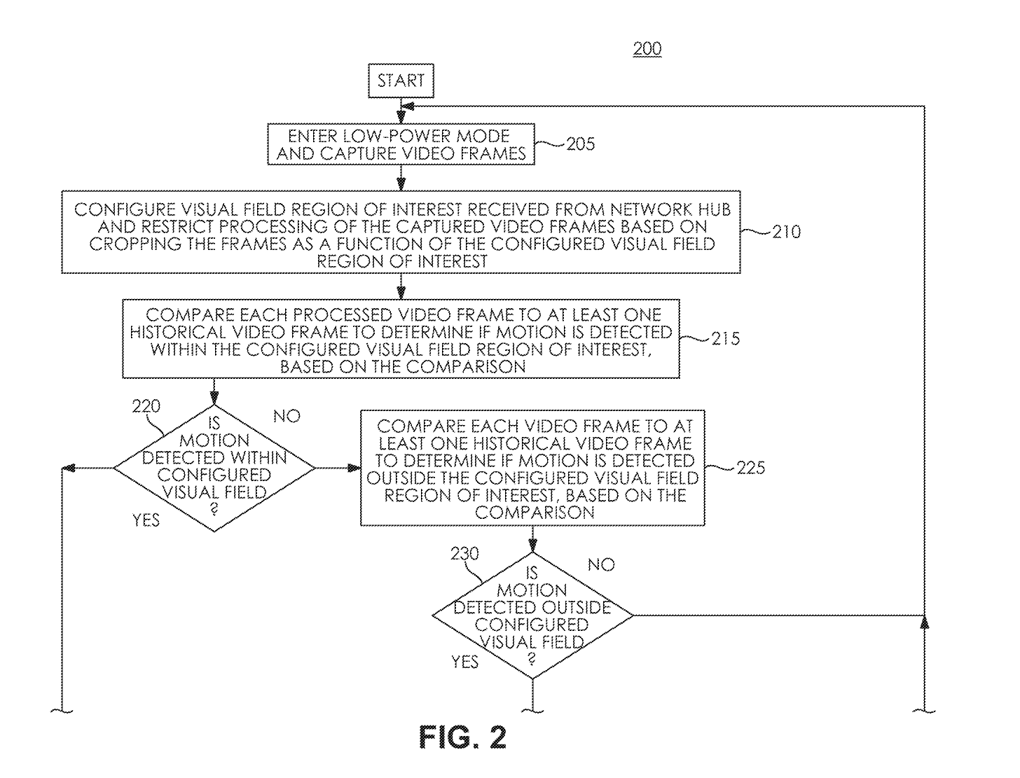

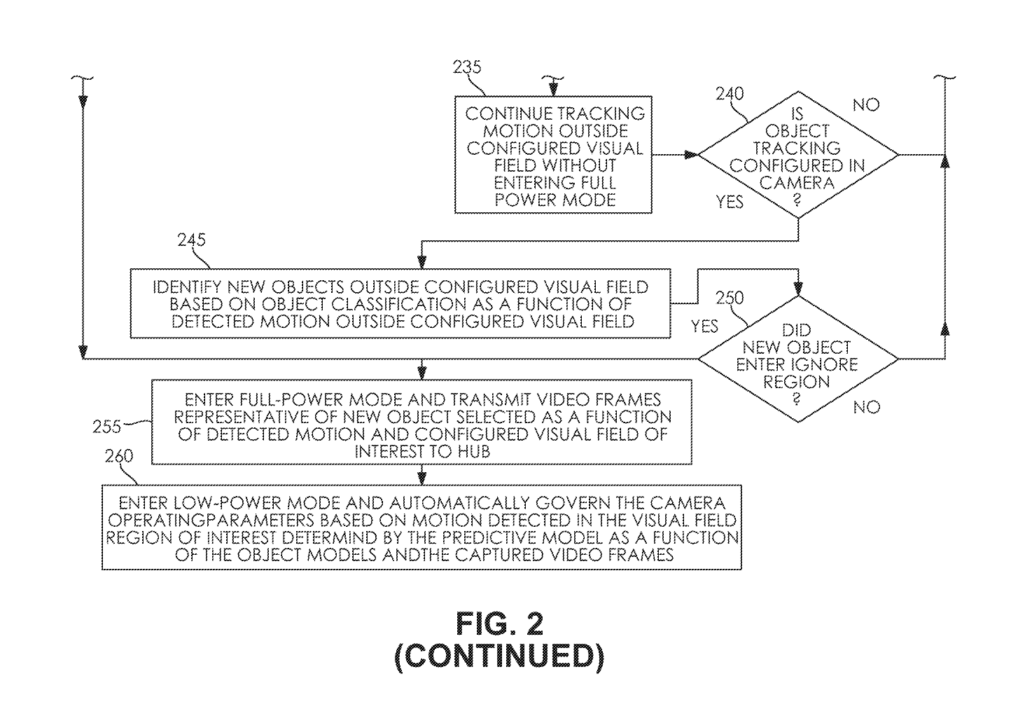

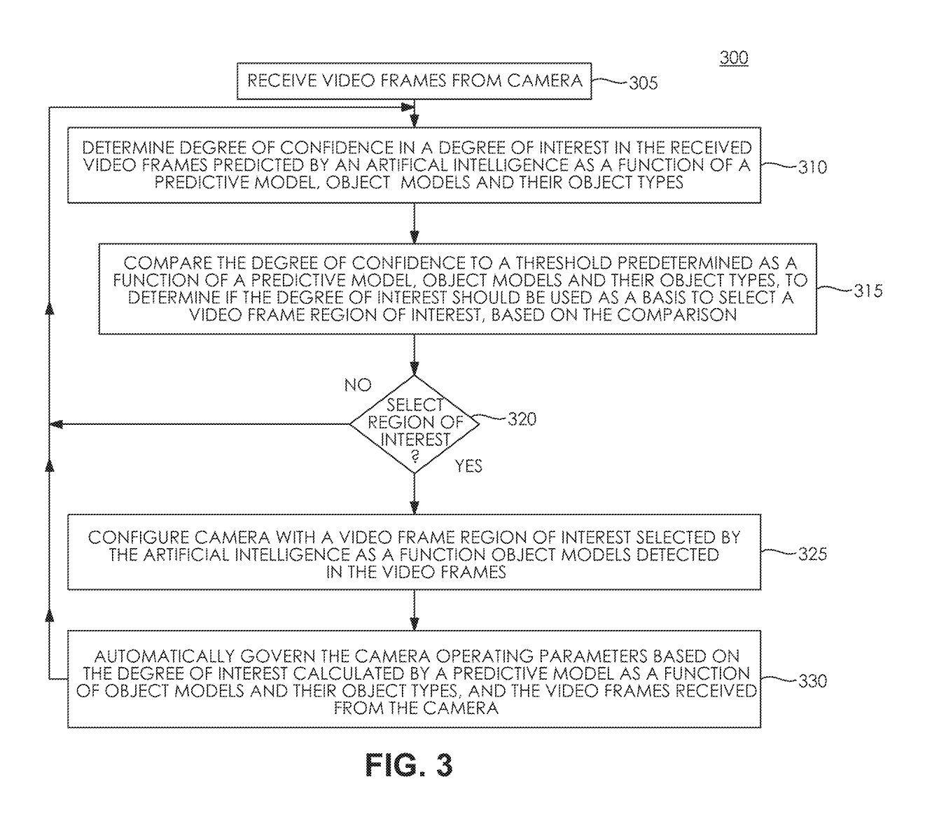

To aid understanding, this document is organized as follows. First, automatically governing operating parameters of a camera based on the visual field region of interest determined by an exemplary artificial intelligence configured in an embodiment network hub is disclosed with reference to FIG. 1. Then, with reference to FIG. 2, the discussion turns to exemplary embodiments that describe automatically governing camera operational parameters based on a region of interest determined by an artificial intelligence as a function of video frames selected by the camera. Specifically, an exemplary process to automatically govern camera operational parameters adapted as a function of the configured region of interest, is disclosed. Finally, with reference to FIG. 3, an exemplary process to configure the camera with the region of interest predicted by the hub is presented.

FIG. 1 depicts a collaboration view of an exemplary camera transmitting video frames selected by the camera based on detected motion to a network hub configured with an artificial intelligence adapted to predict a region of interest within the selected video frames, configuring the camera with the region of interest predicted by the hub, and managing the energy consumption of the camera based on automatically governing camera operational parameters adapted as a function of the region of interest. In FIG. 1, exemplary camera 105 transmits the video frames 110 selected as a function of motion 115 in the visual field region of interest 120 to exemplary network hub 125. In the depicted embodiment, the motion 115 detected by the camera 105 includes smoke billowing from a chimney attached to a house, a tree moving in the wind, and a human approaching the house. In the illustrated embodiment, the visual field region of interest 120 is the upper right quadrant of a captured image represented in one of the video frames 110. In the depicted embodiment, the visual field region of interest encompasses the smoke billowing from the chimney attached to the house. In the illustrated embodiment, the tree moving in the wind and the human approaching the house are outside of the visual field region of interest. In the depicted embodiment, the network hub 125 configures the camera 105 with the visual field region of interest 120. In the illustrated embodiment, the network hub 125 determines the visual field region of interest 120 based on artificial intelligence, image processing, object detection, and object tracking. In the depicted embodiment, the network hub 125 includes processor 130 in electrical communication with memory 135. In the illustrated embodiment, the depicted memory 135 includes program memory 140 and data memory 145. In the depicted embodiment, the depicted program memory 140 includes processor-executable program instructions implementing VCME (Video Camera Management Engine) 150. In various implementations, the depicted memory 135 may contain processor executable program instruction modules configurable by the processor 130 to be adapted to provide image input capability, video encoding, video decoding, image output capability, image sampling, spectral image analysis, correlation, autocorrelation, Fourier transforms, image buffering, image filtering operations including adjusting frequency response and attenuation characteristics of spatial domain and frequency domain filters, or anomaly detection. In the illustrated embodiment, the processor 130 is communicatively and operably coupled with the camera interface 155 and the network interface 160. In some embodiments, the network interface 160 may be a wireless network interface. In various implementations, the network interface 160 may be a wired network interface. In some designs, the network interface 160 may include wired and wireless network interfaces. In the illustrated embodiment, the camera interface 155 is adapted to interface the hub 125 with more than one camera 105. In the depicted embodiment, the camera interface 155 includes a control path and a data path allocated to each camera. In the illustrated embodiment, each camera interface 155 data path is adapted to receive video or image data from a camera, and transmit video or image data to a camera. In the illustrated embodiment, the network hub 125 configures the visual field region of interest 120 in the camera 105 based on transmitting video or image data to the camera via the camera interface 155 data path. In the depicted embodiment, each camera interface control path is adapted to transmit control data 165 to a camera. In the illustrated example, the camera 105 receives control data 165 from the network hub 125. In the depicted example, the control data 165 includes an adjustment to camera on-time. Control data transmitted to camera 105 from the network hub 125 may be, for example, camera operational parameters governed by the hub, including such parameters as the camera on-time, or a command to power down the camera. Artificial intelligence may be configured in the hub 125 to include a predictive model and object models. The network hub 125 may train the predictive model to predict a degree of interest and object type of objects detected by the network hub 125 as a function of the video frames 110 and the object models. In the depicted embodiment, the camera 105 includes processor 170 in electrical communication with memory 172. In the illustrated embodiment, the depicted memory 172 includes program memory 175 and data memory 177. In the depicted embodiment, the depicted program memory 175 includes processor-executable program instructions implementing VRME (Video Region Management Engine) 180. In the illustrated embodiment, the processor 170 is communicatively and operably coupled with the camera input/output module 182 the network interface 180, and the image sensor 187. In various embodiments, the processor 170 may automatically govern the camera 105 operating parameters based on motion 115 detected in the visual field region of interest 120. In some embodiments, the camera 105 may implement object tracking. In various implementations, the camera 105 may implement object detection. In various implementations, the depicted memory 172 may contain processor executable program instruction modules configurable by the processor 170 to be adapted to provide image input capability, video encoding, video decoding, image output capability, image sampling, spectral image analysis, correlation, autocorrelation, Fourier transforms, image buffering, image filtering operations including adjusting frequency response and attenuation characteristics of spatial domain and frequency domain filters, or anomaly detection.

FIG. 2 depicts a process flow of an exemplary Video Region Management Engine (VRME). In FIG. 2, an embodiment VRME 180 is depicted transmitting to a network hub 125 video frames 110 selected by the camera 105 based on detected motion 115 within the configured region of interest 120, and managing the energy consumption of the camera based on automatically governing camera operational parameters adapted as a function of the region of interest 120. The method depicted in FIG. 2 is given from the perspective of the VRME 180 executing as program instructions on the processor 170 of the camera 105, depicted in FIG. 1. In some embodiments, the VRME 180 may execute as a cloud service governed by the processor 170. The depicted method 200 begins at step 205 with the processor 170 configuring the camera 105 to enter low-power mode and capture video frames 110. The method continues at step 210 with the processor 170 configuring a visual field region of interest 120 received from a network hub and restricting processing of the captured video frames 110 based on cropping the frames as a function of the configured visual field region of interest 120. The method continues at step 215 with the processor 170 comparing each processed video frame to at least one historical video frame to determine if motion 115 is detected within the configured visual field region of interest 120, based on the comparison. At step 220, a test is performed by the processor 170 to determine if motion 115 is detected within the configured visual field 120, based on the comparison performed by the processor 170 at step 215. Upon a determination by the processor 170 at step 220 that motion 115 is detected, the method continues at step 255 with the processor 170 configuring the camera 105 to enter full-power mode and transmit video frames 110 selected as a function of detected motion 115 and configured visual field of interest 120 to hub 125. The method continues at step 260 with the processor 170 configuring the camera 105 to enter low-power mode and automatically govern the camera 105 operating parameters based on motion 115 detected in the visual field region of interest 120, and the method continues at step 205. Upon a determination by the processor 170 at step 220 that motion 115 is not detected, the method continues at step 225 with the processor 170 comparing each video frame 110 to at least one historical video frame to determine if motion 115 is detected outside the configured visual field region of interest 120, based on the comparison. At step 230 a test is performed by the processor 170 to determine if motion 115 is detected outside the configured visual field 120, based on the comparison performed by the processor 170 at step 225. Upon a determination by the processor 170 at step 230 that motion 115 is not detected outside the configured visual field 120, the method continues at step 205 with the processor 170 configuring the camera 105 to enter low-power mode and capture video frames 110. Upon a determination by the processor 170 at step 230 that motion 115 is detected outside the configured visual field 120, the method continues at step 235 with the processor 170 configuring the camera 105 to continue tracking motion 115 outside the configured visual field of interest 120 without entering full-power mode. At step 240 a test is performed by the processor 170 to determine if object tracking is configured in the camera 105. Upon a determination by the processor 170 at step 240 that object tracking is not configured in the camera 105, the method continues at step 205 with the processor 170 configuring the camera 105 to enter low-power mode and capture video frames 110. Upon a determination by the processor 170 at step 240 that object tracking is configured in the camera 105, the method continues at step 245 with the processor 170 configuring the camera 105 to identify new objects entering an ignore region outside the configured visual field 120 based on object classification as a function of detected motion 115 outside the configured visual field 120. At step 250 a test is performed by the processor 170 to determine if a new object entered an ignore region outside the configured visual field 120. Upon a determination by the processor 170 at step 250 that a new object did not enter an ignore region outside the configured visual field 120, the method continues at step 205 with the processor 170 configuring the camera 105 to enter low-power mode and capture video frames 110. Upon a determination by the processor 170 at step 250 that a new object did enter an ignore region outside the configured visual field 120, the method continues at step 255 with the processor 170 configuring the camera 105 to enter full-power mode and transmit video frames 110 selected as a function of detected motion 115 and configured visual field of interest 120 to hub 125. The method continues at step 260 with the processor 170 configuring the camera 105 to enter low-power mode and automatically govern the camera 105 operating parameters based on motion 115 detected in the visual field region of interest 120, and the method continues at step 205.

FIG. 3 depicts a process flow of an exemplary Video Camera Management Engine (VCME). In FIG. 3, an embodiment VCME 150 is depicted configuring camera 105 with visual field region of interest 120 and receiving from the camera 105 video frames 110 selected by the camera 105 as a function of the configured visual field region of interest 120. The method depicted in FIG. 3 is given from the perspective of the VCME 150 executing as program instructions on the processor 130 of the network hub 125, depicted in FIG. 1. In some embodiments, the VCME 150 may execute as a cloud service governed by the processor 130. The depicted method 300 begins at step 305 with the processor 150 receiving video frames 110 from the camera 105. The method continues at step 310 with the processor 150 determining a degree of confidence in a degree of interest in the received video frames 110 predicted by an artificial intelligence as a function of a predictive model, object models and their object types. The method continues at step 315 with the processor 150 comparing the degree of confidence determined at step 310 to a threshold predetermined as a function of a predictive model, object models and their object types, to determine if the degree of interest should be used as a basis to select a video frame region of interest 120, based on the comparison. At step 320, a test is performed by the processor 150 to determine if a visual field region of interest 120 should be selected based on the degree of interest in the received video frames 110 predicted by the artificial intelligence. Upon a determination by the processor 150 that a new visual field region of interest 120 should not be selected, the method continues at step 305 with the processor 150 receiving video frames 110 from the camera 105. Upon a determination by the processor 150 that a new visual field region of interest 120 should be selected, the method continues at step 325 with the processor 150 configuring the camera 105 with a video frame 110 region of interest 120 selected by the artificial intelligence as a function of object models and the received video frames 110. The method continues at step 330 with the processor 150 automatically governing the camera 105 operating parameters based on the degree of interest calculated by a predictive model as a function of object models and their object types, and the video frames 110 received from the camera 105. Then, the method continues at step 305.

Although various embodiments have been described with reference to the Figures, other embodiments are possible. For example, in some embodiments, battery powered cameras may be managed with artificial intelligence configured in a local hub to intelligently manage camera power consumption. In various implementations, camera power consumption may be managed based on multiple layers of machine learning, object detection, region of interest filtering, and motion detection. In an illustrative example, object detection and object type determination based on artificial intelligence in a network hub may be combined with region-of-interest filtered motion detection configured in a camera to precisely manage the camera's power consumption. For example, a camera configured to detect motion in a field of interest may transition from a low power mode to a full power mode when motion is detected in the visual field of interest. In some embodiments, motion outside the configured visual field of interest may be considered a region in which motion may be ignored by the camera. For example, a camera detecting motion outside a configured field of interest may continue tracking the motion without fully powering up. In some embodiments, motion tracked outside the configured visual field of interest may be stored and forwarded to a central server if the moving object enters the visual field of interest from outside the region of interest. In some scenarios of exemplary usage, battery powered security cameras may provide a multitude of benefits to users including ease of setup and ease of distribution. In various examples of use, battery powered security cameras are a popular way to provide visibility around a home. In an illustrative example, a camera if connected to an intelligent WiFi hub may manage the power consumption with a higher degree of accuracy than a camera without AI, or a camera running AI on the camera, or a camera running AI in the cloud.

In some embodiments, a set of cameras (and potentially other sensors) may be connected to an intelligent WiFi hub. In various implementations, machine learning may be performed on this hub which in some designs may be both the network connectivity hub of the camera and a processor designed to perform AI. In an illustrative example, the hub may be designed to have sufficient computational power (including a GPU) to perform the AI with very low latency (<0.1 s) so that every frame can be evaluated for its potential security concern. In an illustrative example of exemplary usage, such low-latency AI evaluation of potential security concern may allow a very precise management of power. For example, the low-latency AI may determine that it is only a cat entering the area of interest, and that there are no people within the frame, so to disregard this particular event.

In an illustrative scenario exemplary of prior art usage without AI, battery life may be very short—for example the Netgear Arlo Pro has a very short battery life (<10 days in areas of lots of motion). In some exemplary prior art scenarios, AI on cameras (such as cameras plugged into a wall) may consume excessive power. For example, running a simple AI filter on a battery-powered camera would more than double (or more likely 10×) the power consumption of the camera—having a direct and proportional impact on its battery life. In an illustrative example, cloud-based AI may be both too slow and too expensive to perform real-time analysis for all motion events for a battery powered camera (each frame must be analyzed in real-time [<100 ms] to determine if the camera should stay on). In some embodiments, AI may be configured to identify relevant objects within the field of view of battery powered cameras. In various implementations, every frame may be economically analyzed for interesting things in the field of a camera. In some exemplary scenarios of use, analyzing every frame in the cloud for interesting things in the field of a camera may be prohibitively expensive for most consumers.

Various embodiments may include several features: 1. Motion region filtering on the camera: In some embodiments, the camera may be configured to capture video frames and detect motion in a configured visual field of interest without enabling WiFi. In an illustrative example, by performing a first-layer of filtering on the cameras (using the battery) comparing one frame to the prior frames, a degree of motion can be determined in various regions of the camera's field of view. In an illustrative scenario exemplary of usage of some embodiments, if an area is not in the key field of view, the motion event can continue to be tracked without “waking up” the camera's WiFi. In some embodiments, continuing to track a motion event without “waking up” the camera's WiFi may save up to 50% of camera power usage. 2. Remote video initiation: In some scenarios exemplary of prior art use, some prior art security cameras respond to a video event by either waiting until the event is complete, then saving it to the cloud or an “NVR”, or by notifying a third party who can then request the video feed. In some embodiments of the present invention, every captured frame may be immediately streamed to an AI for evaluation once the area of motion is within an area of interest configured in the camera. In some embodiments, by streaming from the camera (instead of notifying from the camera) no frames of video are lost (such loss occurs in the remote request approach) and the event can immediately be evaluated (which is not possible in the post-event sending approach). 3. Hub-based AI: In various embodiments of the present invention, machine learning may be performed on the hub, in a device which may be both the network connectivity hub of the camera and a processor designed to perform AI. In various implementations, the “Hub” (our WiFi hub) may be designed to have sufficient computational power (including a GPU) to perform the AI with very low latency (<0.1 s) so that every frame can be evaluated for its potential security concern. In an illustrative example, such low latency AI may allow very precise management of power; for example, the AI may determine that it is only a cat entering the area of interest, and that there are no people within the frame, so to disregard this particular event. 4. AI-informed region of interest filtering: In some designs, using the AI, the hub may then determine areas of frequent “noise” events—e.g., the precise region around a tree which frequently waves in the wind. In some embodiments, such an “ignore region” region may then be sent to the camera as an ignore region which will be used in #1 (Motion region filtering on the camera) above, closing the loop. In various implementations, object-tracking may be implemented on the camera, which may identify new objects entering the field of view and could independently run object classification on each object if it enters the region of interest—otherwise staying in “WiFi” off mode.

In some scenarios exemplary of prior art usage, motion detection may be insufficient to filter out events like trees waving in the wind, and cloud-based AI may be too slow to both achieve the precision required for security, and avoid ignoring potential security threats. In various scenarios exemplary of prior art cameras, region of interest filters implemented only in real-time [<100 ms] may not save battery, as they are only able to turn on and/or off the camera. In various embodiments of the present invention, the WiFi power on the camera may be governed as a function of detected motion in a region of interest, saving as much as 50+% of the battery while staying “awake” in case an event does enter the region of interest. In various implementations of embodiments of the present invention, battery powered cameras may be adapted to create an “aware but low-power mode” whereby the WiFi module is disabled until needed. Such adaptation of battery powered cameras with an “aware but low-power mode” may result in increased power management using low power mode. In various scenarios exemplary of prior art cameras, video frames may be captured by the camera and be sent out by the camera on the network one way only, limiting access to useful information. In some embodiments of the present invention, two-way communication with cameras may be implemented in real-time interaction with the hub. Such two-way real-time interaction of video frames from the camera, configured regions of interest from the hub determined by artificial intelligence in the hub, and frames from the camera with motion detected in the configured regions of interest, may result in more sensitive security threat detection that may also be more efficient with battery-powered devices. In some embodiments of the present invention, an “aware but low-power mode” may include various settings. For example, such an “aware but low-power mode” may be set automatically or manually, and may turn off the WiFi chip to potentially save 50% or more of camera power. In some embodiments of the present invention, object detection may be implemented on the camera. In various embodiments of the present invention including object detection on the camera, models of objects to be detected may be configured in the camera by the hub. In some embodiments, the hub may filter notifications based on detected object type. For example, the hub may not notify a homeowner if an object identified as the homeowner's cat enters the visual field of interest configured in the camera, as it is just their cat. Various embodiments of the present invention may save 500-600 msec to 1 second in response time to detected motion events based on initiating video feeds from the camera instead of initiating feeds from the hub. In exemplary scenarios of prior art usage, a cloud service may notify the camera to start a feed after the camera detects motion, resulting in delays and lost video. In some embodiments of the present invention, the camera may be configured to white out all areas in camera except an object of interest. For example, a camera may be configured to obscure all regions of an image except the face of a tracked human object.

In some exemplary usage scenarios of various embodiments, irrelevant events may be quickly and intelligently filtered if they do not contain objects of interest as identified by an AI (e.g., identify people, dogs, etc.); or identify the specific residents of a home, further reducing power consumption based on management of the camera's power and filtering events and notifications based on the identification by the AI. In some embodiments, the AI may be customized to the individual home while protecting privacy. In various implementations, an embodiment distributed AI may be customized to recognize the residents of a particular home without ever sharing the images of these homeowners to the cloud, based on, for example, methods for distributed training of artificial intelligence to recognize objects in video while protecting privacy as described with reference to FIGS. 1-6 of U.S. patent application Ser. No. 15/491,950, entitled “Distributed Deep Learning Using a Distributed Deep Neural Network,” filed by Selinger, David Lee, et al., on Apr. 19, 2017 the entire contents of which are herein incorporated by reference. In some designs, battery-powered cameras may be configured to run object tracking on the camera. In some examples, an object to be tracked may be configured in the camera by the network hub. In some examples, object tracking on the camera may result in increased camera energy efficiency as a result of sending only events related to objects of interest to the network hub from the camera. Various implementations may be useful in home security to protect the perimeter of homes.

In some embodiments, event filtering conditions may be determined as a function of the type of an identified or tracked object. In some examples, the type of object may be determined by artificial intelligence configured in a network hub based on video frames or images received by the hub from a camera. In an illustrative example of exemplary usage, prior art cameras may turn on for a fixed period of time under two filtering conditions: 1. Motion detector activation for a period of time or with a certain first derivative; and, 2. Motion in area-of-interest of camera. In some embodiments, a real time AI as described with reference to FIGS. 1-4 of U.S. patent application Ser. No. 15/492,011, entitled “System and Method for Event Detection Based on Video Frame Delta Information in Compressed Video Streams,” filed by Selinger, David Lee, et al., on Apr. 20, 2017 the entire contents of which are herein incorporated by reference, may be configured to quickly determine the type of a moving object. In an illustrative example, object type may be “cat”, “dog”, or “son”. Such exemplary real-time moving object type determination may create various benefits. For example, in some embodiments, in response to type of object detected by AI in the hub, the system may cut-short the camera fixed on-time, saving battery. In some designs, object type information may also be used to filter notifications to the owner.

In various embodiments, ambient or environmental conditions such as illumination may be adapted in real-time based on evaluation of image quality, to improve detection capability based on improvement in image quality. In exemplary scenarios of prior art use, some current cameras may set the illumination level according to an ambient light sensor. In some embodiments illumination may be changed in real-time based on evaluation of image quality metrics. For example, in some embodiments, illumination may be increased or decreased in real-time as a function of type of object information.

In some embodiments, bitrate may be adapted in real-time based on evaluation of image quality, to improve detection capability based on improvement in image quality. In exemplary scenarios of prior art use, some current cameras may set the bitrate level according to the codec or video profile information. In some embodiments bitrate may be changed in real-time based on evaluation of image quality metrics. For example, in some embodiments, bitrate may be increased or decreased in real-time as a function of type of object information.

In various designs, AI for camera management at the hub may be cheaper than in the cloud. In some embodiments, AI for camera management at the hub may be faster than AI in the cloud. In an illustrative example of exemplary prior art usage, cloud services may not be optimized for real-time performance, as they do not run RTOSES. In some examples of the prior art, cloud services cannot be configured with RTOSES because they are virtualized. In an illustrative example of a virtualized cloud service, the OS inside the Virtual Machine calls to the underlying OS, which is never an RTOS because to be an RTOS would require one VM to be able to exclude other VMs from access to hardware, which is not now possible.

In various designs, such real-time AI-based camera management may advantageously provide the opportunity to control actuators or other outputs in real-time in response to events or objects detected by the AI in video or images received by the hub. For example, in some embodiments, actuators or other outputs controlled in real-time in response to events or objects detected by the AI in video or images received by the hub may include a pan-and-tilt following a burglar detected by the AI.

In some embodiments, filtering conditions may be changed in real time. In exemplary scenarios of usage, prior art cameras may not be able to change their filtering conditions in real-time. In some examples, prior art cameras may not, for example, adapt filtering conditions to ignore objects that are not of interest; the best they could conceivably do is to send the information to the web and be is behind real-time. In some embodiments, an exemplary AI-managed camera may detect that the object in the field of view is a cat and so for the next 10 minutes, we will not trigger on cat-sized objects.

In various exemplary scenarios of prior art usage, battery powered cameras are not configured with AI. In some exemplary scenarios of prior art usage, cameras configured with AI may typically have wired power. In some illustrative scenarios or prior art usage, excessive battery drain may result from running AI on a battery powered camera.

Some embodiments may include Artificial Intelligence (AI) configured in a network hub communicatively and operatively coupled with a wireless camera. In some designs, cameras communicatively and operatively coupled with the network hub may be Common Off The Shelf (COTS) cameras.

In some implementations, the network hub may include more than one network connection. In some embodiments, the network hub may include a Wi-Fi connection. In various designs, the network hub may include a wired power connection. In some examples, the network hub may include a wired connection to the network. In various designs, cameras may stream video frames or images to the hub. In various designs, more than one AI may be configured in the hub. In some examples, various AIs configured in the hub may be adapted to detect a diversity of various objects. In some examples, the hub may be configured to direct cameras, for example, a hub may be configured to control the position or orientation of a camera through pan, tilt, or zoom operations directed by the hub. In some designs, the hub may be configured to reboot or control cameras. In various implementations, the hub may be adapted to maintain the health of cameras; for example, the hub may be configured to send an alert if a camera goes offline, or predict when a camera battery will need to be replaced and send a battery change alert. In some examples, the hub may be configured to control a camera to focus on objects in the visual field of the camera. In exemplary scenarios of prior art usage, controlling a camera to focus on objects in the visual field of the camera cannot be done after the camera captures the images; for example, the hub may be configured to control camera focus, lighting, and bitrate changes, in response to image quality metrics evaluated by the AI configured in the hub. In some designs, the AI configured in the hub may determine specifics about object including identifying specific individuals. In some examples, the hub may be adapted with a High Dynamic Range (HDR) imaging feature usable in real time. For example, in illustrative examples of prior art usage, useful real-time HDR may not be possible due to latency in the cloud. In some embodiments, the real-time cloud latency limitation of the prior art failure to provide useful real-time HDR may be overcome as a result of providing a local hub adapted with an HDR feature. In some examples, camera video feeds may be 30 frame/sec, 60 frame/sec, or faster. Some embodiments may respond with useful object detection or AI predictions or decisions within one to two frames, based on deltas or differences between frames. In an exemplary scenario illustrative of the response time of cloud-based systems, prior art response times may be in the range of several seconds or longer. In some examples of illustrative usage scenarios, fast response times may be important for security purposes. Some embodiments may advantageously provide detection response times an order of magnitude faster and more accurate. In an illustrative example, if someone turns their head into a camera's visual field only for a quick moment, the event could be missed in the latency of cloud system, however an embodiment hub system would not lose the imagery. In various implementations, a hub system may identify specific objects, such as, for example, a specific cat, a specific dog, or a specific human. For example, an embodiment hub system may be fast and accurate enough to identify the difference between a homeowner's dog and a random dog. In some embodiments, the AI configured in the hub may be personalized for various places, for example, in a specific home, the AI may be configured to expect certain specific objects.

In an illustrative example according to an embodiment of the present invention, the system and method are accomplished through the use of one or more computing devices. As depicted in FIG. 1, one of ordinary skill in the art would appreciate that an exemplary network hub 105 appropriate for use with embodiments of the present application may generally be comprised of one or more of a Central processing Unit (CPU) which may be referred to as a processor, Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While some of the foregoing drawings and description set forth functional aspects of some embodiments of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are exemplary, and provided for illustrative disclosure of enablement and exemplary best mode of various embodiments. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus, comprising:
a camera management module, comprising: a network hub adapted to configure a connected device with a visual field region of interest predicted by an artificial intelligence configured in the hub as a function of video frames received from the connected device; and,
a camera, operatively and communicatively coupled with the camera management module, the camera adapted to:
receive from the camera management module configuration of a visual field of interest;
transmit video frames selected as a function of the configured visual field of interest to the camera management module; and,
automatically govern the camera operational parameters as a function of motion detected by the camera in the visual field region of interest.

2. The apparatus of claim 1, wherein the camera further comprises a wireless network interface.

3. The apparatus of claim 1, wherein the camera is a battery-powered camera.

4. The apparatus of claim 1, wherein the network hub further comprises a GPU.

5. The apparatus of claim 1, wherein the motion detected by the camera further comprises motion within the configured visual field of interest.

6. The apparatus of claim 1, wherein the network hub further comprises artificial intelligence adapted to determine the object type detected as a function of video frames received from the connected device.

7. The apparatus of claim 6, wherein the operational parameters further comprise on-time adapted as a function of motion detected in a region of interest selected by the network hub as a function of the object type.

8. The apparatus of claim 6, wherein the operational parameters further comprise bitrate adapted as a function of motion detected in a region of interest selected by the network hub as a function of the object type.

9. The apparatus of claim 6, wherein the camera management module further comprises operably coupled illumination controlled by the camera management module as a function of an image quality metric.

10. The apparatus of claim 6, wherein the camera management module further comprises the network hub adapted to transmit to a homeowner notification filtered in real time as a function of object type.

11. An apparatus, comprising:
a camera management module, comprising: a network hub adapted to configure a connected device with a visual field region of interest predicted by an artificial intelligence as a function of an object type detected in video frames received from the connected device; and,
a camera, operatively and communicatively coupled with the camera management module, the camera adapted to:
transmit to the camera management module video frames selected by the camera as a function of motion detected by the camera in a visual field region of interest configured in the camera by the camera management module; and,
automatically govern the camera operational parameters as a function of motion detected by the camera in the visual field region of interest.

12. The apparatus of claim 11, wherein the camera is a battery-powered camera.

13. The apparatus of claim 11, wherein the network hub further comprises a GPU configured with sufficient computational power to perform the AI as a function of each video frame received from the connected device in no more than 0.1 sec per frame.

14. The apparatus of claim 11, wherein the operational parameters further comprise on-time governed as a function of motion detected in a region of interest selected by the network hub as a function of the object type.

15. The apparatus of claim 11, wherein the operational parameters further comprise bit-rate governed as a function of motion detected in a region of interest selected by the network hub as a function of the object type.

16. The apparatus of claim 11, wherein the camera management module further comprises the network hub adapted to transmit to a homeowner notification filtered in real time as a function of the type of object detected.

17. An apparatus, comprising:
a camera management module, comprising: a network hub adapted to configure a connected device to visually track objects detected within a visual field region of interest predicted by an artificial intelligence as a function of an object type detected in video frames received from the connected device; and,
a camera, operatively and communicatively coupled with the camera management module, the camera adapted to:
detect motion in a visual field region of interest configured in the camera by the camera management module;
track visual objects of interest configured in the camera by the camera management module;
automatically pan, tilt, focus, or zoom based on objects tracked by the camera; and,
transmit to the camera management module video frames selected as a function of motion detected by the camera.

18. The apparatus of claim 17, wherein the camera management module further comprises the network hub adapted to adjust notification filtering in real time as a function of detected object type.

19. The apparatus of claim 17, wherein the camera management module further comprises the network hub adapted to configure the camera with a predictive model and an object model.

20. The apparatus of claim 19, wherein the camera further comprises governing the camera operational parameters as a function of the type of object detected by artificial intelligence configured in the camera.

21. An apparatus, comprising a camera adapted to:
accept configuration of a visual field of interest;
transmit video frames selected by the camera as a function of the configured visual field of interest; and,
automatically govern the camera operational parameters as a function of motion detected by the camera in the visual field region of interest.

22. The apparatus of claim 21 wherein the camera further comprises object tracking.

23. The apparatus of claim 21 wherein the camera further comprises object detection.

24. The apparatus of claim 23 wherein the camera further comprises configuration to obscure image areas exclusive to a detected object.
